(19) United States
(12) Patent Application Publication
(10) Pub. No.: US 2026/0238063 A1
(43) Pub. Date: Aug. 13, 2026

(54) ELECTRIC MOTOR ASSEMBLY HAVING A TRAY

(71) Applicant: Schaeffler Technologies AG & Co. KG, Herzogenaurach (DE)

(72) Inventor: Vishal Jadhav, Kent, OH (US)

(73) Assignee: Schaeffler Technologies AG & Co. KG, Herzogenaurach (DE)

(21) Appl. No.: 19/052,828

(22) Filed: Feb. 13, 2025

(51) Int. Cl. H02K 3/50

(52) U.S. Cl. CPC H02K 3/50; H02K 2203/09

(57) ABSTRACT

An electric motor assembly includes a stator that a rotor rotates relative to about an axis. The stator includes a stator core that extends axially in a first axial direction from a first axial end to a second axial end opposite the first axial end. A plurality of windings extend along the stator core, each of which respectively includes a terminal end that is positioned axially beyond the second axial end of the stator core in the first axial direction. A busbar to which at least one of the plurality of windings is fixed proximate to the terminal end of the at least one winding. A tray is coupled to and supports the busbar. The tray includes a busbar carrier that houses the busbar and includes a post that extends to a distal end of the post. A winding stabilizer defines a receiver within which the post is received.

### FIELD OF THE DISCLOSURE

The present disclosure generally relates to an electric motor assembly. More specifically, the present disclosure relates to an electric motor assembly that includes a tray for supporting a busbar stabilizing a plurality of windings extending therethrough.

### BACKGROUND OF THE DISCLOSURE

Electric motors often include windings that are fixed to busbars. During operation of these electric motors, forces may be applied to the windings that cause stress at the connection points between the windings and the busbar.

### SUMMARY OF THE DISCLOSURE

According to a first aspect of the present disclosure, an electric motor assembly includes a stator that a rotor rotates relative to about an axis. The stator includes a stator core that extends axially in a first axial direction from a first axial end to a second axial end opposite the first axial end. A plurality of windings extend along the stator core, each of which respectively includes a terminal end that is positioned axially beyond the second axial end of the stator core in the first axial direction. A busbar to which at least one of the plurality of windings is fixed proximate to the terminal end of the at least one winding. A tray is coupled to and supports the busbar. The tray defines at least one aperture within which at least one of the plurality of windings extends and at least one well adjacent to the at least one aperture and through which the at least one winding extends. The at least one well receives a binding agent therein to fix the at least one winding with the tray.

Embodiments of the first aspect of the disclosure can include any one or a combination of the following features:
the at least one aperture extends from a first opening to a second opening that is axially offset from the first opening, the at least one well is adjacent to the at least one aperture at the second opening, and at least one winding extends through the first opening, the second opening, and the at least one well, such that the terminal end of the at least one winding is axially nearest to the at least one well and axially farthest from the first opening;
a portion of the tray that defines at least a portion of the at least one aperture tapers inward as the portion extends axially toward the second opening, such that the first opening is larger than the second opening;
the portion of the tray that tapers inward as the portion extends axially toward the second opening terminates at a position that is axially offset from the second opening;
the at least one aperture includes a first aperture and a second aperture, and the at least one well includes a first well, and wherein the first aperture and the second aperture are adjacent to the first well;
the at least one aperture further includes a third aperture, and the at least one well further includes a second well, and wherein the third aperture is adjacent to the second well and is not adjacent to the first well;
the tray includes a busbar carrier that houses the busbar and includes a post that extends to a distal end of the post; and a winding stabilizer that defines the at least one aperture, the at least one well, and a receiver, wherein the post of the busbar carrier is received within the receiver defined by the winding stabilizer;
the distal end of the post is deformed, such that removal of the post from the receiver is inhibited; and
the post is fixed to the winding stabilizer via a binding agent.

According to a second aspect of the present disclosure, an electric motor assembly a stator that a rotor rotates relative to about an axis. The stator includes a stator core that extends axially in a first axial direction from a first axial end to a second axial end opposite the first axial end. A plurality of windings extend along the stator core, each of which respectively includes a terminal end that is positioned axially beyond the second axial end of the stator core in the first axial direction. A busbar to which at least one of the plurality of windings is fixed proximate to the terminal end of the at least one winding. A tray is coupled to and supports the busbar. The tray includes a busbar carrier that houses the busbar and includes a post that extends to a distal end of the post. A winding stabilizer defines a receiver within which the post is received.

Embodiments of the second aspect of the disclosure can include any one or a combination of the following features:
the distal end of the post is deformed, such that removal of the post from the receiver is inhibited;
the post is fixed to the winding stabilizer via a binding agent;
the busbar carrier and the winding stabilizer are formed of plastic;
the winding stabilizer defines at least one aperture within which at least one of the plurality of windings extends;
the winding stabilizer defines at least one well adjacent to the at least one aperture, wherein the at least one well has a binding agent received therein to fix the at least one winding with the tray;
the at least one aperture extends from a first opening to a second opening that is axially offset from the first opening, the at least one well is adjacent to the at least one aperture at the second opening, and at least one winding extends through the first opening, the second opening, and the at least one well, such that the terminal end of the at least one winding is axially nearest to the at least one well and axially farthest from the first opening;
a portion of the tray that defines at least a portion of the at least one aperture tapers inward as the portion extends axially toward the second opening, such that the first opening is larger than the second opening;
the portion of the tray that tapers inward as the portion extends axially toward the second opening terminates at a position that is axially offset from the second opening; and
the at least one aperture includes a first aperture and a second aperture, and the at least one well includes a first well, and wherein the first aperture and the second aperture are adjacent to the first well.

According to a third aspect of the present disclosure, an electric motor assembly includes a stator that a rotor rotates relative to about an axis. The stator includes a stator core that extends axially in a first axial direction from a first axial end to a second axial end opposite the first axial end. A plurality of windings extend along the stator core, each of which respectively includes a terminal end that is positioned axially beyond the second axial end of the stator core in the first axial direction. A busbar to which at least one of the plurality of windings is fixed proximate to the terminal end of the at least one winding. A tray includes a busbar carrier that houses the busbar and includes a post that extends to a distal end of the post. A winding stabilizer defines at least one aperture within which at least one of the plurality of windings extends. At least one well is adjacent to the at least one aperture and within which a binding agent is received to fix the at least one winding with the tray, and a receiver, wherein the post of the busbar carrier is received by the receiver defined by the winding stabilizer.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a cross-sectional view of an electric drive unit that includes an electric motor assembly that has a stator and a rotor;

FIG. 2 is a perspective view of a portion of an electric motor assembly, illustrating a stator that includes a stator core and a plurality of windings, a plurality of busbars to which the plurality of windings are fixed, and a tray that supports the plurality of busbars and through which the plurality of windings extend, according to one embodiment;

FIG. 3 is an enlarged view of an area of the electric motor assembly of FIG. 2, according to one embodiment;

FIG. 4 is a perspective view of a tray of the electric motor assembly, according to one embodiment;

FIG. 5 is an elevational view of the tray of the electric motor assembly, according to one embodiment;

FIG. 6 is a cutaway view of a portion of the tray illustrated in FIG. 5, taken at line VI-VI, illustrating receivers and a well defined by the tray and windings shown in phantom that respectively extend through the receivers and the well defined by the tray, according to one embodiment;

FIG. 7 is an exploded perspective view of the tray, illustrating a busbar carrier that includes a includes a plurality of posts and a winding stabilizer that includes a plurality of receivers that are configured to receive the posts of the busbar carrier;

FIG. 8 is an elevational view of the tray, illustrating the busbar carrier assembled with the winding stabilizer, such that the posts are received within the receivers, and the distal ends of the posts in a retention condition, wherein the distal ends of the post are larger than the corresponding receivers that the posts are received within, according to one embodiment; and

FIG. 9 is a cutaway view of a portion of the tray of FIG. 8 taken at line IX-IX, illustrating the post of the busbar carrier received within the receiver of the windings stabilizer, according to one embodiment.

The components in the figures are not necessarily to scale, emphasis instead being placed upon illustrating the principles described herein.

### DETAILED DESCRIPTION

Additional features and advantages of the disclosure will be set forth in the detailed description which follows and will be apparent to those skilled in the art from the description, or recognized by practicing the disclosure as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “axial” and derivatives thereof, such as “axially,” shall be understood to refer to a direction along the axis about which a component (e.g., rotor) is configured to rotate in operation of the apparatus described herein. Further, the term “radial” and derivatives thereof, such as “radially,” shall be understood in relation to the axis of the aforementioned component. For example, “radially outboard” refers to further away from the axis, while “radially inboard” refers to nearer to the axis. The term “circumferential” and derivatives thereof, such as “circumferentially,” shall be understood in relation to the axis of the aforementioned component.

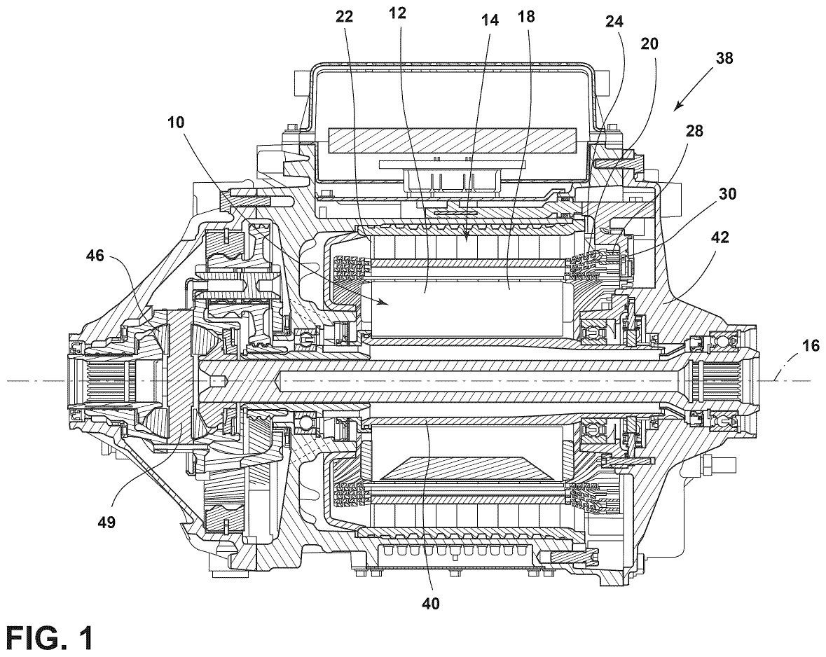

Referring now to FIGS. 1-9, an electric motor assembly 10 includes a rotor 12 and a stator 14 that is disposed radially outboard of the rotor 12. The rotor 12 rotates relative to the stator 14 about an axis 16. The stator 14 includes a stator core 18 and a plurality of windings 20. The stator core 18 extends axially in a first direction from a first axial end 22 to a second axial end 24 opposite the first axial end 22. The plurality of windings 20 extend along the stator core 18. Each of the plurality of windings 20 respectively includes a terminal end 26 that is positioned axially beyond the second axial end 24 of the stator core 18 in the first axial direction. At least one of the plurality of windings 20 is fixed to a busbar 28 proximate to the terminal end 26 of the at least one winding 20. A tray 30 is coupled to and supports the busbar 28. The tray 30 defines at least one aperture 32 through which the at least one winding 20 extends and at least one well 34 adjacent to the at least one aperture 32 and through which the at least one winding 20 extends. The at least one well 34 has a binding agent 36 received therein to fix the at least one winding 20 with the tray 30.

Referring now to FIG. 1, the electric motor assembly 10 may be a portion of an electric drive unit 38 for a vehicle, as illustrated in FIG. 1. The electric motor assembly 10 includes the rotor 12 and the stator 14 that is disposed radially outboard of the rotor 12. As illustrated in FIG. 1, a rotor shaft 40 may be positioned radially inboard of the rotor 12 and may be configured to rotate about the axis 16 during operation of the electric motor assembly 10. The electric drive unit 38 may include a variety of other components, including a housing 42 that houses the electric motor assembly 10, a gearset 44 operably coupled with the rotor shaft 40, and/or a differential 46 operably coupled with the gearset 44.

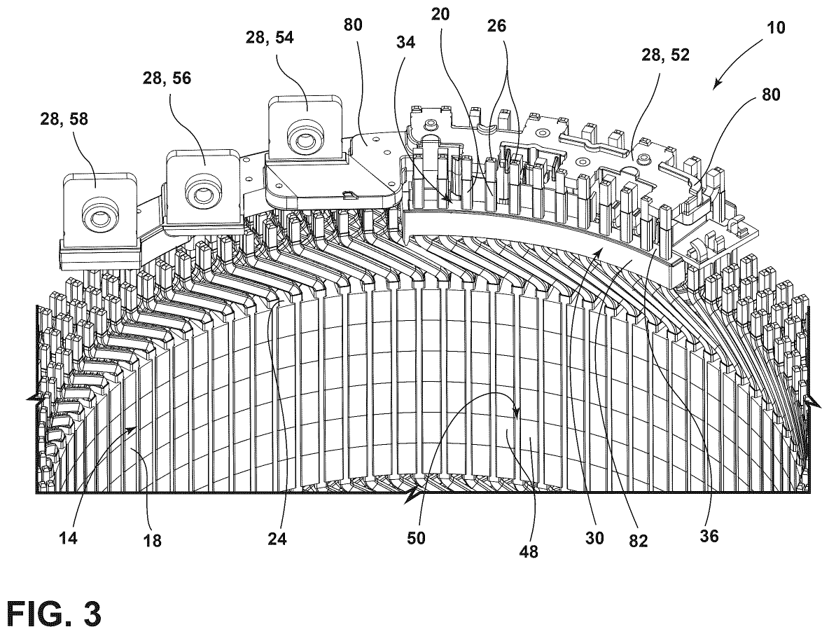

Referring now to FIGS. 1-3, the stator 14 of the electric motor assembly 10 includes the stator core 18. As illustrated in FIGS. 1-3, the stator core 18 extends axially in the first axial direction from the first axial end 22 of the stator core 18 to the second axial end 24 of the stator core 18 that is opposite the first axial end 22. As illustrated in FIG. 3, the stator core 18 can include a plurality of teeth 48 that are circumferentially spaced apart to define a plurality of gaps 50 between adjacent teeth 48. The stator 14 further includes the plurality of windings 20. The plurality of windings 20 extend along the stator core 18. In various implementations, the windings 20 extend within the gaps 50 defined between adjacent teeth 48 of the stator core 18, as illustrated in FIG. 3. Each of the windings 20 includes the terminal end 26 that is positioned axially beyond the second axial end 24 of the stator core 18 in the first axial direction. As described further herein, the windings 20 may be fixed to the busbar 28 proximate the terminal ends 26 of the windings 20.

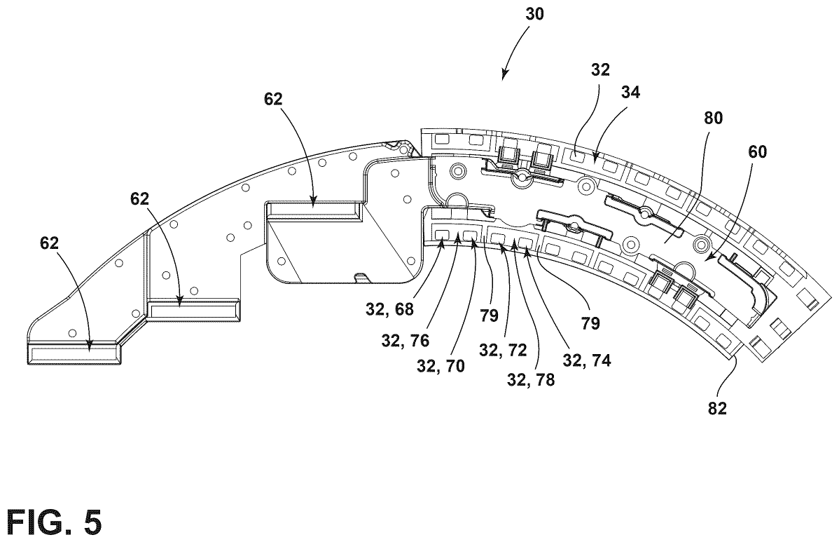

Referring still to FIGS. 1-5, the electric motor assembly 10 includes the busbar 28. In various implementations, the electric motor assembly 10 includes a plurality of busbars 28. For example, as illustrated in FIG. 5, the electric motor assembly 10 includes a first busbar 52, a second busbar 54, a third busbar 56, and a fourth busbar 58. In the exemplary embodiment illustrated in FIG. 3, the first busbar 52 is neutral, the second busbar 54 is U-phase, the third busbar 56 is V-phase, and the fourth busbar 58 is W-phase. It is contemplated that various numbers of busbars 28 can be included in the electric motor assembly 10, and the busbars 28 may be associated with various phases, in some embodiments.

Referring still to FIGS. 1-3, the plurality of windings 20 are fixed to the one or more busbars 28. In various implementations, the plurality of windings 20 are fixed to the one or more busbars 28 proximate to the terminal ends 26 of the windings 20. The windings 20 may be fixed to the one or more busbars 28 in a variety of manners. For example, in some implementations, the windings 20 may be welded to the one or more busbars 28. In some implementations, the windings 20 may be fixed to the one or more busbars 28 via a conductive binding agent.

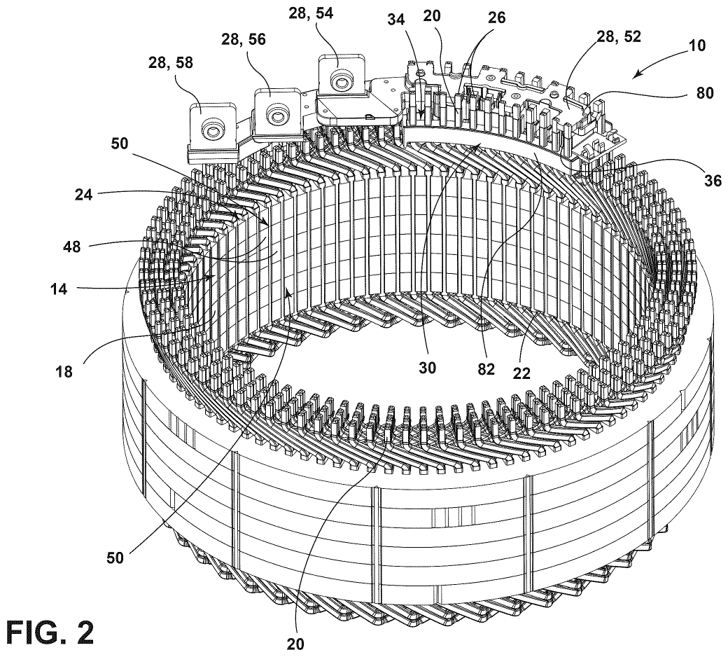

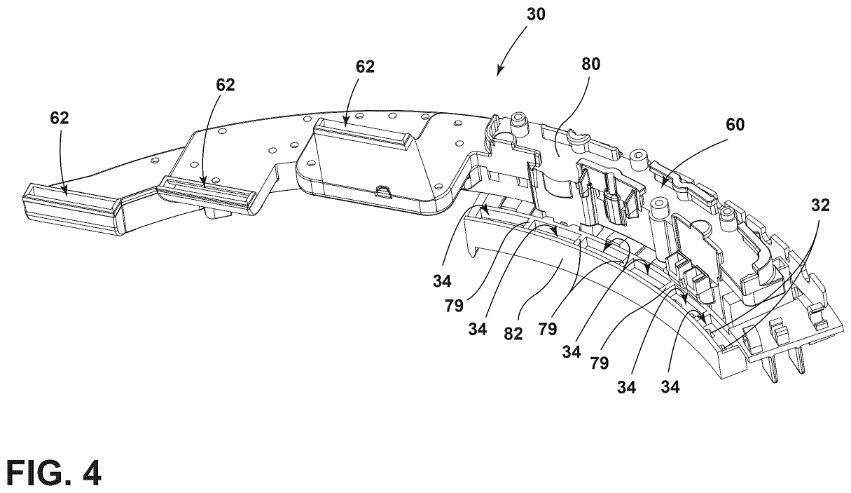

Referring now to FIGS. 2-9, the electric motor assembly 10 includes the tray 30. The tray 30 is coupled to the busbar 28 and supports the busbar 28. As illustrated in FIGS. 4, 5, and 9, the tray 30 defines a recess 60 for receiving the first busbar 52, and a plurality of hollows 62 for receiving the second, third, and fourth busbars 54, 56, 58, therein, respectively, as illustrated in FIGS. 2 and 3. The busbars 28 are housed and supported by the tray 30 while disposed in the recess 60 and/or the hollows 62 defined by the tray 30. In various implementations, the tray 30 defines at least one aperture 32. The aperture may be positioned axially between the busbar 28 and the stator core 18 of the electric motor assembly 10. As illustrated in FIGS. 4-6 and 8, the tray 30 defines a plurality of apertures 32. The apertures 32 are configured to receive corresponding windings 20 therethrough, as illustrated in FIGS. 3 and 4.

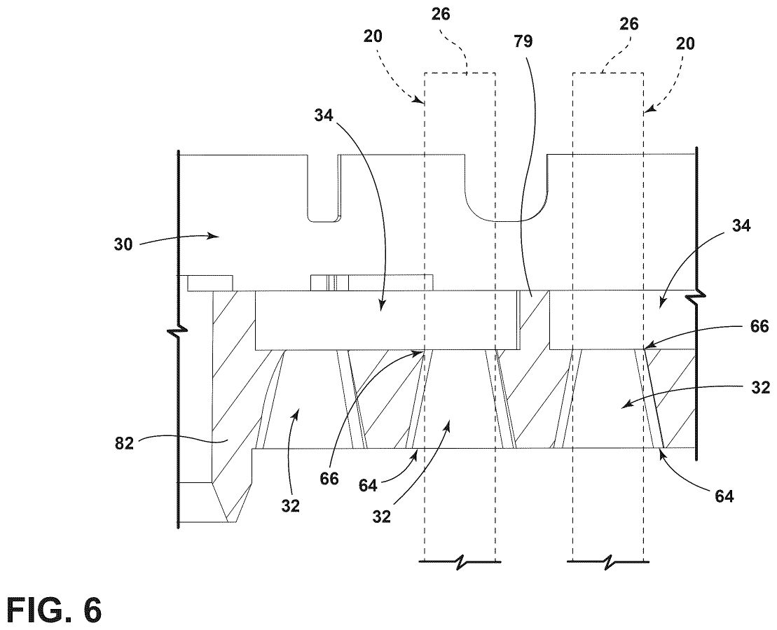

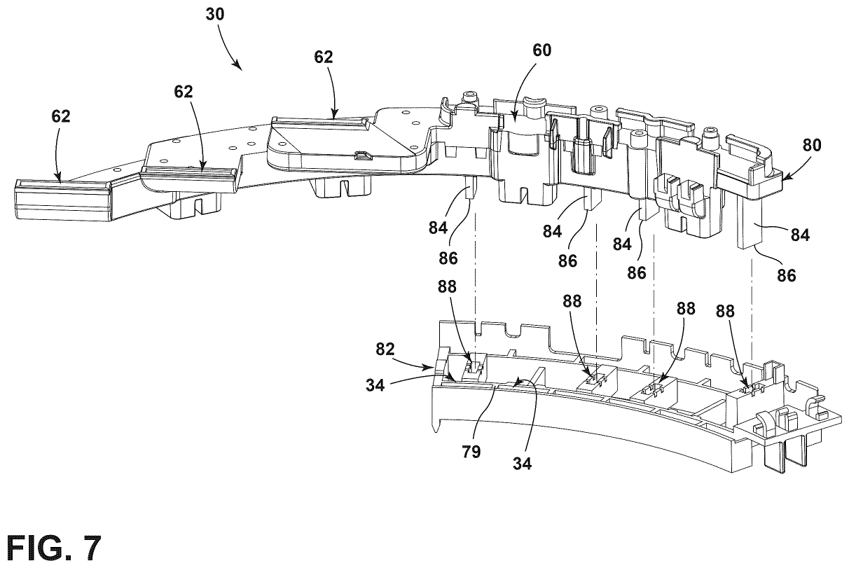

Referring now to FIGS. 6 and 7, in various implementations, at least one aperture 32 defined by the tray 30 extends from a first opening 64 to a second opening 66 that is axially offset from the first opening 64. As illustrated in FIG. 7, a portion of the tray 30 that defines at least a portion of the at least one aperture 32 may taper inward as the portion extends axially in the first axial direction toward the second opening 66, such that the first opening 64 of the at least one aperture 32 is larger than the second opening 66 of the at least one aperture 32, as illustrated in FIG. 7. In the embodiment illustrated in FIG. 7, the tray 30 defines a plurality of apertures 32 that extend from the first opening 64 to the second opening 66 in the first axial direction. As illustrated, the first opening 64 is larger than the second opening 66 due to the inward tapering of the portions of the tray 30 that define the apertures 32. The inward tapering of the portions of the tray 30 that define the apertures 32 can result in a friction fit with windings 20 extending therethrough, such that the movement of the windings 20 in directions parallel to the lengthwise direction of the portion of the winding 20 that extends through the aperture 32 is restricted. Although the portion of the tray 30 that defines the windings 20 is illustrated in FIG. 7 as tapering inward from the first opening 64 to the second opening 66, it is contemplated that the inward tapering portion can terminate at a position that is axially offset from the second opening 66 in some embodiments. In such embodiments, another portion of the tray 30 that defines the aperture 68, 70, 72, 74 may extend from the terminus of the inward tapering portion along a trajectory that is different than the inward tapered portion. In an exemplary embodiment, the portion that extends from the terminus to the second opening 66 may extend with less or no taper in a direction substantially parallel to the direction that the corresponding winding 20 is configured to extend through the aperture 32.

Referring now to FIGS. 4-6, in various embodiments, the tray 30 defines at least one well 34. The at least one well 76, 78 can have a binding agent 36 received therein for fixing the at least one winding 20 with the tray 30 and/or for providing a greater fixation area between the at least one winding 20 and the tray 30, such that stress on the connection between the tray 30 and the at least one winding 20 is more widely distributed. A variety of types of binding agents 36 are contemplated (e.g., epoxy, resin, adhesive, etc.). The at least one well 34 may be adjacent to the at least one aperture 32 defined by the tray 30. For example, as illustrated in FIG. 6, the at least one aperture 32 extends from the first opening 64 to the second opening 66 that is axially offset from the first opening 64, and the at least one well 34 is adjacent to the at least one aperture 32 at the second opening 66. In various implementations, the at least one well 34 and the at least on aperture 32 are adjacent, such that the at least one well 34 and the at least one aperture 32 are in fluid communication with each other via the second opening 66 of the at least one aperture 32.

As further illustrated in FIG. 6, the at least one winding 20 extends through the first opening 64 of the aperture 32, the second opening 66 of the aperture 32, and the at least one well 34, such that the terminal end 26 of the at least one winding 20 is axially nearest to the at least one well 34 and axially farthest from the first opening 64. Arranged as such, the at least one winding 20 may generally obstruct the at least one aperture 32, such that the at least one well 34 may retain the binding agent 36 therein for fixing the tray 30 and the at least one winding 20, as illustrated in FIG. 6.

In various embodiments, the at least one aperture includes a plurality of apertures 32, and the at least one well includes a plurality of wells 34. For example, as illustrated in FIGS. 4 and 5, the tray 30 defines a plurality of apertures 32, including a first aperture 68, a second aperture 70, a third aperture 72, and a fourth aperture 74, and the tray 30 defines a plurality of wells 34 including a first well 76 and a second well 78. In the illustrated embodiment, the first aperture 68 and the second aperture 70 are adjacent to the first well 76. The third and fourth apertures 72, 74 are adjacent to the second well 78 and are not adjacent to the first well 76. A divider 79 is positioned between the first well 76 and the second well 78, such that the third and fourth apertures 72, 74 are not adjacent to the first well 76.

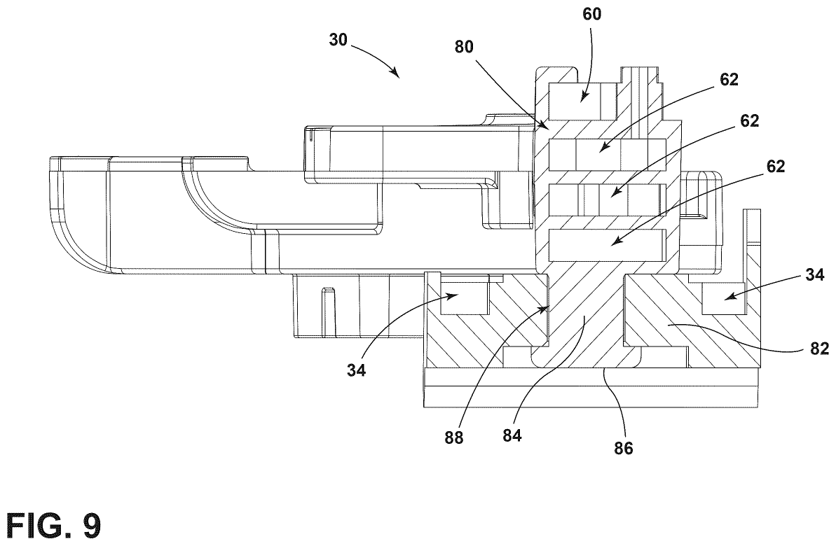

Referring now to FIGS. 7-9, the tray 30 of the electric motor assembly 10 can include a busbar carrier 80 and a winding stabilizer 82. The busbar carrier 80 can house the busbar 28, in various embodiments. For example, as illustrated in FIG. 9, the busbar carrier 80 includes the plurality of hollows 62 and the recess 60 that are configured to receive the busbars 28 therein. The winding stabilizer 82 is configured to have the at least one winding 20 coupled thereto to stabilize the winding during operation of the electric motor assembly 10. In various implementations, the winding stabilizer 82 defines the at least one aperture 32 and the at least one well 34 through which the at least one winding 20 is configured to extend.

Referring still to FIGS. 7-9, in various implementations, the busbar carrier 80 and the winding stabilizer 82 are and/or originate as distinct components and are assembled and/or fixed to each other in an assembled state of the tray 30. In various embodiments, the busbar carrier 80 includes a post 84 that extends outward from an adjacent portion of the busbar carrier 80 to a distal end 86 of the post 84, and the winding stabilizer 82 defines a receiver 88 that receives the post 84 of the busbar carrier 80 therein in the assembled state of the tray 30. In the embodiment illustrated in FIG. 7, the busbar carrier 80 includes a plurality of posts 84, and the winding stabilizer 82 includes a corresponding plurality of receivers 88 that are configured to receive the posts 84 therein.

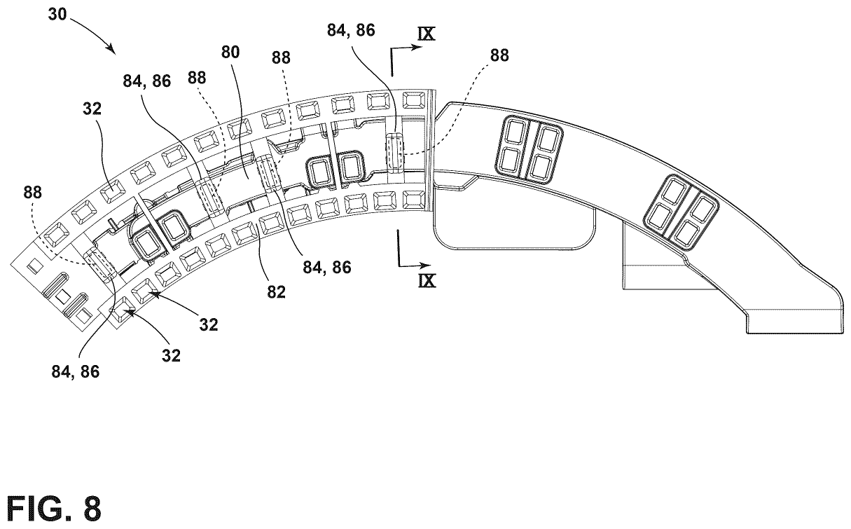

In various embodiments, after the post 84 of the busbar carrier 80 is received within the receiver 88 of the winding stabilizer 82, the busbar carrier 80 and the winding stabilizer 82 are fixed to each other. In some embodiments, the busbar carrier 80 and the winding stabilizer 82 are fixed to each other via a binding agent. For example, a binding agent may be applied to the post 84 of the busbar carrier 80 and/or the portion of the winding stabilizer 82 that defines the receiver 88, such that the post 84 and the portion of the winding stabilizer 82 are adhered to each other to fix the busbar carrier 80 to the winding stabilizer 82. In some embodiments, the distal end 86 of the post 84 of the busbar carrier 80 is deformed after insertion of the post 84 through the receiver 88, such that removal of the post 84 from the receiver 88 is inhibited. As illustrated in FIG. 7, wherein the winding stabilizer 82 is in a spaced relationship with the busbar carrier 80, the distal ends 86 of the posts 84 of the busbar carrier 80 are sized to fit within the corresponding receivers 88 defined by the winding stabilizer 82. Conversely, in FIGS. 8 and 9, wherein the posts 84 are received within the corresponding receivers 88, the distal ends 86 of the posts 84 are larger (due to deformation of the distal ends 86 after insertion through the corresponding receivers 88) than the adjacent opening 64, 66 to the receiver 88 through which the distal ends 86 of the posts 84 must travel in order to be removed from the receivers 88. A variety of methods of deformation are contemplated (e.g., infrared welding and/or riveting, ultrasonic welding and/or riveting, hot air staking, heat staking, etc.). In an exemplary implementation, the busbar carrier 80 of the tray 30 is plastic and the winding stabilizer 82 is plastic, and after insertion of the posts 84 into the corresponding receivers 88, the distal ends 86 of the posts 84 are deformed via infrared welding to the winding stabilizer 82, such that the busbar carrier 80 and the winding stabilizer 82 are fixed to each other.

It is to be understood that variations and modifications can be made on the aforementioned structure without departing from the concepts of the present disclosure, and further it is to be understood that such concepts are intended to be covered by the following claims unless these claims by their language expressly state otherwise.

### List of Reference Numerals

10 electric motor assembly
12 rotor
14 stator
16 axis
18 stator core
20 windings
22 first axial end
24 second axial end
26 terminal end
28 busbar
30 tray
32 aperture
34 well
36 binding agent
38 electric drive unit
40 rotor shaft
42 housing
44 gearset
46 differential
48 teeth
50 gaps
52 first busbar
54 second busbar
56 third busbar
58 fourth busbar
60 recess
62 hollow
64 first opening
66 second opening
68 first aperture
70 second aperture
72 third aperture
74 fourth aperture
76 first well
78 second well
79 divider
80 busbar carrier
82 winding stabilizer
84 post
86 distal end
88 receiver

What is claimed is:

1. An electric motor assembly, comprising:
a stator that a rotor rotates relative to about an axis, the stator comprising:
a stator core that extends axially in a first axial direction from a first axial end to a second axial end opposite the first axial end; and
a plurality of windings that extend along the stator core, each of which respectively includes a terminal end that is positioned axially beyond the second axial end of the stator core in the first axial direction;
a busbar to which at least one of the plurality of windings is fixed proximate to the terminal end of the at least one winding; and
a tray coupled to and supporting the busbar, the tray defining at least one aperture within which at least one of the plurality of windings extends and at least one well adjacent to the at least one aperture and through which the at least one winding extends, wherein the at least one well receives a binding agent therein to fix the at least one winding with the tray.

2. The electric motor assembly of claim 1, wherein the at least one aperture extends from a first opening to a second opening that is axially offset from the first opening, the at least one well is adjacent to the at least one aperture at the second opening, and the at least one winding extends through the first opening, the second opening, and the at least one well, such that the terminal end of the at least one winding is axially nearest to the at least one well and axially farthest from the first opening.

3. The electric motor assembly of claim 2, wherein a portion of the tray that defines at least a portion of the at least one aperture tapers inward as the portion extends axially toward the second opening, such that the first opening is larger than the second opening.

4. The electric motor assembly of claim 3, wherein the portion of the tray that tapers inward as the portion extends axially toward the second opening terminates at a position that is axially offset from the second opening.

5. The electric motor assembly of claim 1, wherein the at least one aperture includes a first aperture and a second aperture, and the at least one well includes a first well, and wherein the first aperture and the second aperture are adjacent to the first well.

6. The electric motor assembly of claim 5, wherein the at least one aperture further includes a third aperture, and the at least one well further includes a second well, and wherein the third aperture is adjacent to the second well and is not adjacent to the first well.

7. The electric motor assembly of claim 1, wherein the tray comprises:
a busbar carrier that houses the busbar and includes a post that extends to a distal end of the post; and
a winding stabilizer that defines the at least one aperture, the at least one well, and a receiver, wherein the post of the busbar carrier is received within the receiver defined by the winding stabilizer.

8. The electric motor assembly of claim 7, wherein the distal end of the post is deformed, such that removal of the post from the receiver is inhibited.

9. The electric motor assembly of claim 7, wherein the post is fixed to the winding stabilizer via a binding agent.

10. An electric motor assembly, comprising:
a stator that a rotor rotates relative to about an axis, the stator comprising:
a stator core that extends axially in a first axial direction from a first axial end to a second axial end opposite the first axial end; and
a plurality of windings that extend along the stator core, each of which respectively includes a terminal end that is positioned axially beyond the second axial end of the stator core in the first axial direction;
a busbar to which at least one of the plurality of windings is fixed proximate to the terminal end of the at least one winding; and
a tray coupled to and supporting the busbar, wherein the tray comprises:
a busbar carrier that houses the busbar and includes a post that extends to a distal end of the post; and
a winding stabilizer that defines a receiver within which the post is received.

11. The electric motor assembly of claim 10, wherein the distal end of the post is deformed, such that removal of the post from the receiver is inhibited.

12. The electric motor assembly of claim 10, wherein the post is fixed to the winding stabilizer via a binding agent.

13. The electric motor assembly of claim 10, wherein the busbar carrier and the winding stabilizer are formed of plastic.

14. The electric motor assembly of claim 10, wherein the winding stabilizer defines at least one aperture within which at least one of the plurality of windings extends.

15. The electric motor assembly of claim 14, wherein the winding stabilizer defines at least one well adjacent to the at least one aperture, wherein the at least one well has a binding agent received therein to fix the at least one winding with the tray.

16. The electric motor assembly of claim 15, wherein the at least one aperture extends from a first opening to a second opening that is axially offset from the first opening, the at least one well is adjacent to the at least one aperture at the second opening, and at least one winding extends through the first opening, the second opening, and the at least one well, such that the terminal end of the at least one winding is axially nearest to the at least one well and axially farthest from the first opening.

17. The electric motor assembly of claim 16, wherein a portion of the tray that defines at least a portion of the at least one aperture tapers inward as the portion extends axially toward the second opening, such that the first opening is larger than the second opening.

18. The electric motor assembly of claim 17, wherein the portion of the tray that tapers inward as the portion extends axially toward the second opening terminates at a position that is axially offset from the second opening.

19. The electric motor assembly of claim 15, wherein the at least one aperture includes a first aperture and a second aperture, and the at least one well includes a first well, and wherein the first aperture and the second aperture are adjacent to the first well.

20. An electric motor assembly, comprising:
a stator that a rotor rotates relative to about an axis, the stator comprising:
a stator core that extends axially in a first axial direction from a first axial end to a second axial end opposite the first axial end; and
a plurality of windings that extend along the stator core, each of which respectively includes a terminal end that is positioned axially beyond the second axial end of the stator core in the first axial direction;
a busbar to which at least one of the plurality of windings is fixed proximate to the terminal end of the at least one winding; and
a tray comprising:
a busbar carrier that houses the busbar and includes a post that extends to a distal end of the post; and
a winding stabilizer that defines at least one aperture within which at least one of the plurality of windings extends, at least one well adjacent to the at least one aperture and within which a binding agent is received to fix the at least one winding with the tray, and a receiver, wherein the post of the busbar carrier is received by the receiver defined by the winding stabilizer.
